(19) United States
(12) Patent Application Publication
(10) Pub. No.: US 2025/0087960 A1
(43) Pub. Date: Mar. 13, 2025

(54) ASE-Based Pump Source For Doped Fiber Amplifiers And Lasers

(71) Applicant: Cybel, LLC., Bethlehem, PA (US)

(72) Inventors: Jean-Marc Delavaux, Pittstown, NJ (US); Robert E. Tench, Allentown, PA (US)

(73) Assignee: Cybel, LLC., Bethlehem, PA (US)

(21) Appl. No.: 18/367,528

(22) Filed: Sep. 13, 2023

(51) Int. Cl. H01S 3/094; H01S 3/067; H01S 3/0941

(52) U.S. Cl. CPC H01S 3/094003; H01S 3/0675; H01S 3/06791; H01S 3/094053; H01S 3/0941; H01S 3/161; H01S 2301/02; H01S 2303/00

(57) ABSTRACT

An amplified spontaneous emission (ASE) source is proposed for use as a pump for fiber-based optical amplifiers and lasers. It is proposed to the ASE source in place of the conventional single-wavelength pump source. The ASE pump power can be generated using a simpler configuration than a conventional fiber-based laser source. Advantageously, it has been found that an ASE source of pump light may be as efficient as the conventional single-wavelength pump source in many applications. Furthermore, given the relatively high levels of pump power required for some applications, ASE pumping is thought to reduce the possibility that fiber nonlinearities (e.g., stimulated Brillouin scattering or Raman scattering) are triggered in the gain fiber.

### TECHNICAL FIELD

The present invention relates to rare earth fiber-based lasers and amplifiers and, more particularly to the utilization of ASE-based pump light in place of conventional single-wavelength (i.e., monochromatic) pump beams to enable energization within the absorption band of the rare-earth doped fiber.

### BACKGROUND OF THE DISCLOSURE

In a typical rare-earth doped fiber amplifier, the associated pump source is a single-wavelength (i.e., monochromatic) element operating at a wavelength associated with generating amplification in the presence of the specific rare earth dopant incorporated within the optical fiber. There has arisen a class of fiber-based amplifiers and lasers that operate within the two micron wavelength region (at times referred to as an “eye safe”) region. Rare earth dopants such as Holmium (Ho) and/or Thulium (Tm) are included in the optical fiber within which amplification occurs. As the potential uses for these “two micron” fiber amplifiers and lasers move into applications such as space-based communication systems, space-earth communication systems, and the like, there is a constant emphasis on reducing the size, weight, and required operating power (SWaP).

The number of individual components utilized within a fiber amplifier is one aspect under review in an attempt to improve the operational advantages of these devices. More broadly, operational improvements are also desired in the fiber-based amplifiers and lasers operating in wavelength bands other than the eye-safe two micron wavelength region (e.g., C-band lasers/amplifiers, L-band lasers/amplifiers, etc.).

### SUMMARY OF THE INVENTION

It is now proposed to use an amplified spontaneous emission (ASE) source as a pump for fiber-based optical amplifiers and lasers (referred to at times as “fiber-based optical devices”), instead of the conventional single-wavelength pump source. An advantage of ASE pump power is that it can be generated using a simpler configuration than a conventional fiber-based laser source. Advantageously, it has been found that an ASE source of pump light may be as efficient as the conventional single-wavelength pump source in many applications. Furthermore, given the relatively high levels of pump power required for some applications, ASE pumping is thought to reduce the possibility that fiber nonlinearities (e.g., stimulated Brillouin scattering or Raman scattering) are triggered in the gain fiber.

It is proposed that any suitable type of ASE source may be used, as long as the generated ASE spectrum includes the wavelength region associated with generating gain in the presence of the particular rare-earth dopant being used. For example, Er-doped optical fiber may utilize an ASE source providing light within a band include a λₚᵤₘₚ of 980 nm, Ho-doped fiber may require an ASE source generating light within a range including a λₚᵤₘₚ of 1860 nm, and the like. Appropriate ASE sources include, but are not limited to, optical semiconductor amplifiers, Raman amplifiers, fiber-based lasers, etc.

An exemplary embodiment of the present invention may take the form of an optical device comprising a section of rare-earth doped optical fiber and an amplified spontaneous emission (ASE) pump source. The ASE pump source is configured to provide broadband ASE pump light spanning a bandwidth Δλ surrounding a selected center wavelength λₚᵤₘₚ, the provided broadband ASE pump light coupled into the section of rare-earth doped optical fiber so as to interact with a rare-earth dopant within a core region of the section of rare-earth doped optical fiber and provide an amplified optical output therefrom.

The inventive optical device may take the form of a doped fiber amplifier device or a fiber laser device.

Other and further aspects and embodiments of the present invention will become apparent during the course of the following discussion and by reference to the drawings related thereto.

### BRIEF DESCRIPTION OF THE DRAWINGS

Referring now to the drawings, where like numerals represent like elements in several views:

FIG. 1 illustrates an exemplary Ho-doped fiber amplifier (HDFA) using an ASE pump source in accordance with the principles of the present invention;

FIG. 2 is a plot depicting the Gaussian spectral shape of an output pump beam from an exemplary ASE source in accordance with the principles of the present invention;

FIG. 3 is a graph of the output signal power (gain) as a function of the 3 dB bandwidth of the ASE pump used to create optical gain within the HDFA of FIG. 1;

FIG. 4 contains a graph depicting the signal output power as a function of input pump power for a particular signal wavelength;

FIG. 5 is a plot comparing the spectral response of the inventive HDFA using an ASE pump source to a prior art HDFA using a single-wavelength pump;

FIG. 6 depicts an exemplary arrangement of an ASE pump source that may be used in an HDFA as shown in FIG. 1;

FIG. 7 depicts an alternative type of ASE pump source, in this case in the form of a two-stage ASE pump source (as compared to the single-stage configuration of FIG. 6);

FIG. 8 is a plot of the spectral evolution of the two-stage ASE source of FIG. 7, as a function of the generated pump power;

FIG. 9 contains plots comparing the output power and noise figure for the inventive ASE-pumped HDFA (as shown in FIG. 1) to the output power and noise figure for a conventional HDFA using a single-wavelength pump source;

FIG. 10 contains plots illustrating the influences on spectral shape associated with including a bandpass filter (of different bandwidths) between the stages of the two-stage ASE pump source of FIG. 7;

FIG. 11 shows another configuration for an ASE pump source, in this case using a power splitting arrangement to create an ASE pump source for use with a set of three different doped fiber amplifiers;

FIG. 12 illustrates another embodiment of the present invention, in this case a doped fiber amplifier based upon using a section of Thulium (Tm)-doped fiber (TDFA) that is similarly supplied pump energy from an ASE pump source;

FIG. 13 illustrates an exemplary Fabry-Perot (FP) fiber-based laser utilizing an ASE pump source in accordance with the teachings of the present invention;

FIG. 14 illustrates an exemplary distributed feedback (DFB) fiber-based laser utilizing an ASE pump source in accordance with the teachings of the present invention; and

FIG. 15 illustrates an exemplary fiber-based ring laser utilizing an ASE pump source in accordance with the teachings of the present invention.

### DETAILED DESCRIPTION

Two-micron holmium (Ho)-doped fiber amplifiers (HDFAs) and lasers are becoming important components in many applications, particularly those where concern for eye safety is a factor. Ho-doped fibers (HDFs) with their broad emission spectrum (e.g., from about 2.00-2.15 μm) and high optical conversion efficiency (for example, a wall-plug efficiency greater than 80%) are quite attractive for use as sources and amplifiers in the general “two micron, eye safe” region.

The following describes improved efficiency in design of HDFAs that has come about by using an ASE source of pump light (the presented ASE pump having a bandwidth anywhere from about 10 nm to 50 nm) instead of the conventional single wavelength source. In particular, it has been found that an HDFA using an ASE pump source may be assembled at a reduced cost compared to prior art designs, utilize a less complicated design, and may be more compact than the prior art. In particular, the disclosed innovation is based on the broadband, ASE-based pumping of the active fiber of the amplifier instead of conventional configurations that rely on pumping from semiconductor lasers or fiber-based lasers that are configured to generate a single wavelength output.

Indeed, the ASE-pumped HDFA formed in accordance with the principles of the present invention is considered to provide at least the following improvements over the prior art: (1) simple and versatile pump design; (2) reduced cost; (3) equivalent (if not superior) optical performance; (4) higher reliability and better wall plug efficiency; and (5) meet SWaP (size, weight, and power) requirements for both terrestrial and space-based applications.

FIG. 1 illustrates an exemplary HDFA 10 formed in accordance with the principles of the present invention. HDFA 10 is shown as comprising a section of doped fiber 12 (referred to at times as active fiber), which in this example comprises a section of HDF. Here, HDF 12 comprises a suitable length of single-clad (SC) doped fiber (the length in the range of 2-3 m, for example). An input signal Sin is provided as an input to HDFA 10, where Sin operates at wavelength within the general two micron region. In one example, λ_{S} may be 2.05 nm, with a 0 dBm (i.e., 1 mW) CW power. Input signal Sin is passed through an input isolator 14 before being introduced into HDF 12.

In accordance with the principles of the present invention, an ASE-based pump source 20 is used to create the pump energy that will interact with the Ho dopant in a manner that increases the optical power of the propagating signal Sin, forming an amplified output signal Sₒᵤₜ. In the configuration as shown in FIG. 1, an output isolator 16 is disposed along the signal path beyond HDF 12. A wavelength division multiplexer (WDM) 18 is included in HDFA 10, with input signal Sin applied as a first input and ASE pump P_{ASE} applied as a second input. Accordingly, the two inputs are multiplexed together onto a common signal path and thereafter introduced into HDF 12. This particular configuration is defined as a “co-pumped” amplifier, since both the input signal and pump propagate through HDF 12 in the same direction.

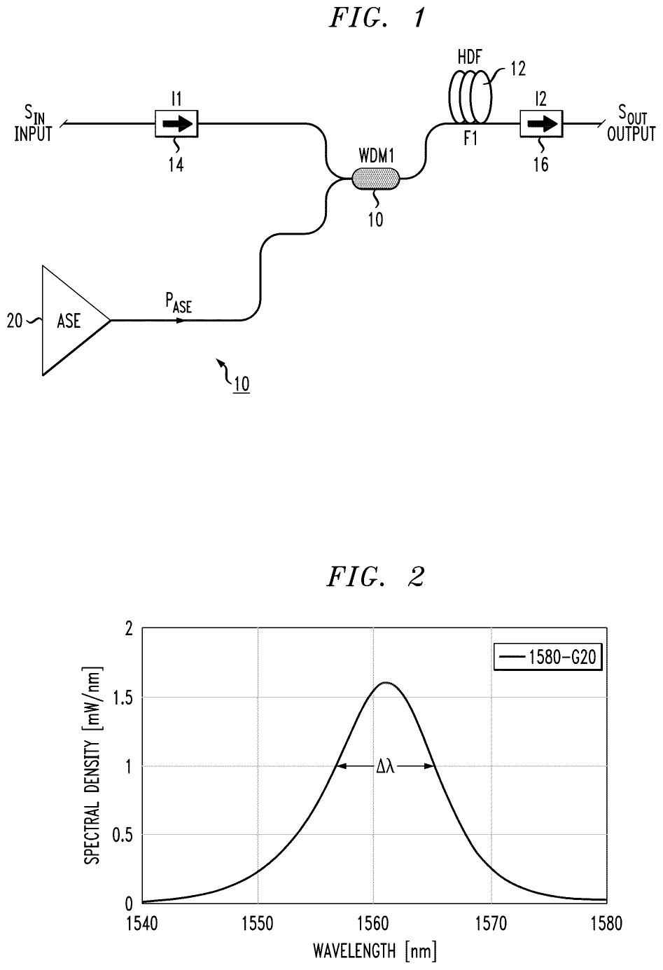

In this particular embodiment, ASE pump source 20 is configured to produce an output exhibiting a Gaussian spectral shape, centered on a pump wavelength λ_{P} of about 1860 nm. FIG. 2 is a plot depicting the Gaussian spectral shape of the pump ASE, indicating its 3 dB bandwidth by the parameter Δλ, and its CW output power as Pₚᵤₘₚ. As will be discussed in detail below, the interaction between pump power, 3 dB bandwidth, doped fiber length, and the like may be controlled in a manner that allows for the amplified output signal Sₒᵤₜ to exhibit power levels similar to prior art HDFAs of more complicated design.

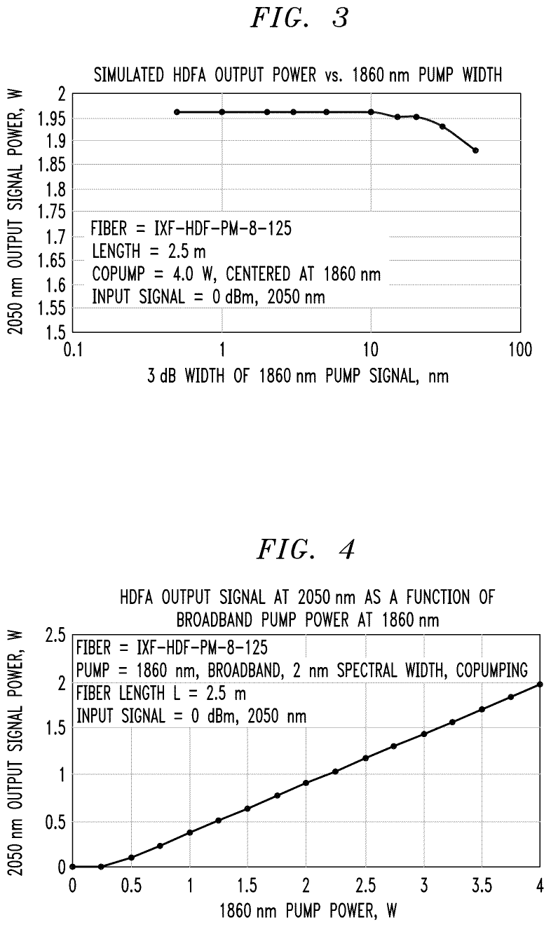

In one implementation, ASE pump source 20 was configured to generate an output power Pₚᵤₘₚ Of about 4.0 W. FIG. 3 is a graph of the output signal power Sₒᵤₜ as a function of the 3 dB bandwidth of P_{ASE}. Evident from this plot is that the bandwidth of the pump may be relatively broad (that is, taking on the form of ASE) up to a value of at least 50 nm and still yield a sufficient amount of output signal power (shown here as generating an output power of about 1.87 W from a 4 W ASE pump source. Indeed, the amount of output power is shown to be relatively stable over a bandwidth extending from less than 1 nm to 10 nm.

FIG. 4 shows the output power of a signal Sₒᵤₜ operating at a signal wavelength of λ_{S}=2050 nm as a function of pump power. This data was collected for using an ASE pump source 20 having a center wavelength of 1860 nm and a bandwidth of about 2 nm. Here, pump source 20 is disposed in the co-propagating configuration of HDFA 10 as shown in FIG. 1. The pump power data is shown as extending from about 0.5 W to about 4.0 W, with the output power of Sₒᵤₜ shown as reaching a value of about 2 W with a 4 W level of pump power. The output power is shown to increase linearly in the same manner as common for prior art (single wavelength) pump sources.

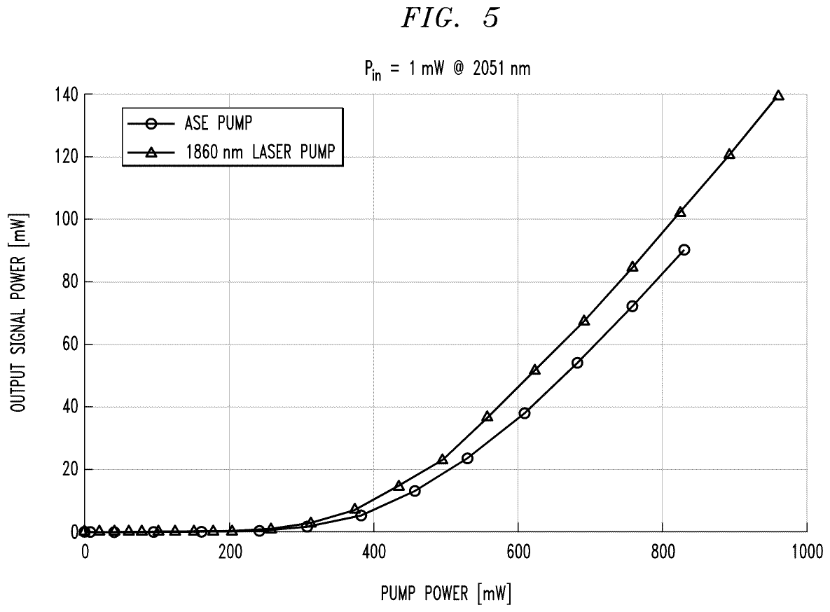

Initial experimental results for the operation of HDFA 10 of FIG. 1 are shown in FIG. 5, which plots signal output power as a function of pump power. For comparison purposes, plot A is associated with the inventive arrangement of FIG. 1, using ASE source 20 to pump HDF 14 (centered at 1860 nm, with FWHM=60 nm), with plot B showing the results associated with using a single-wavelength pump operating at a wavelength of 1860 nm. The results are very similar, showing a difference in output power of only about 0.5 dB, which confirms the hypothesis that ASE pumping is substantially equivalent to single-wavelength laser pumping.

As mentioned above, it is to be understood that any suitable source of ASE light may be used as a pump source for these fiber-based optical devices (i.e., fiber-based optical lasers and fiber-based optical amplifiers). Examples of appropriate sources include, but are not limited to, optical semiconductor amplifiers, Raman amplifiers, fiber-based lasers, and the like.

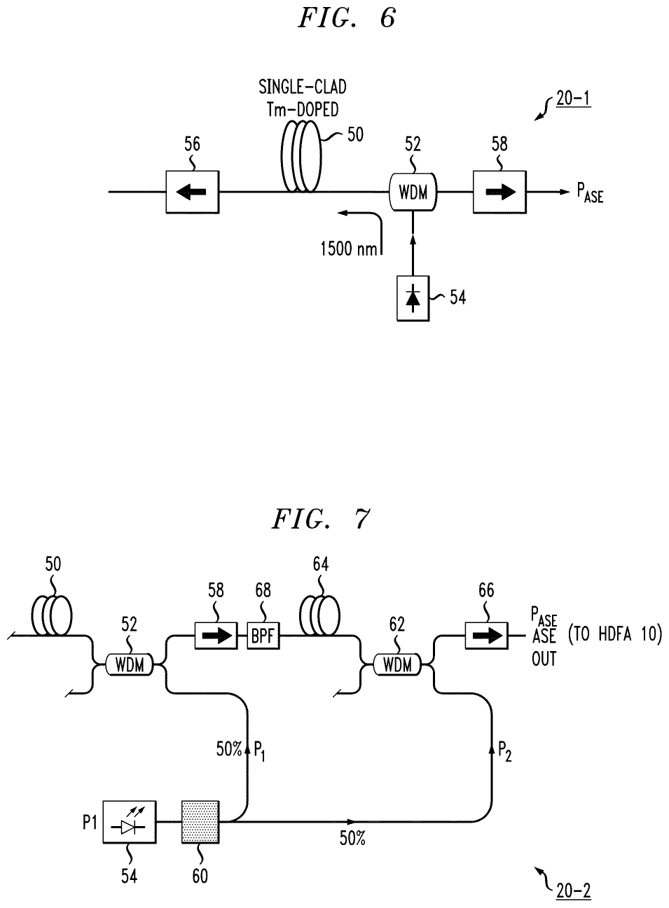

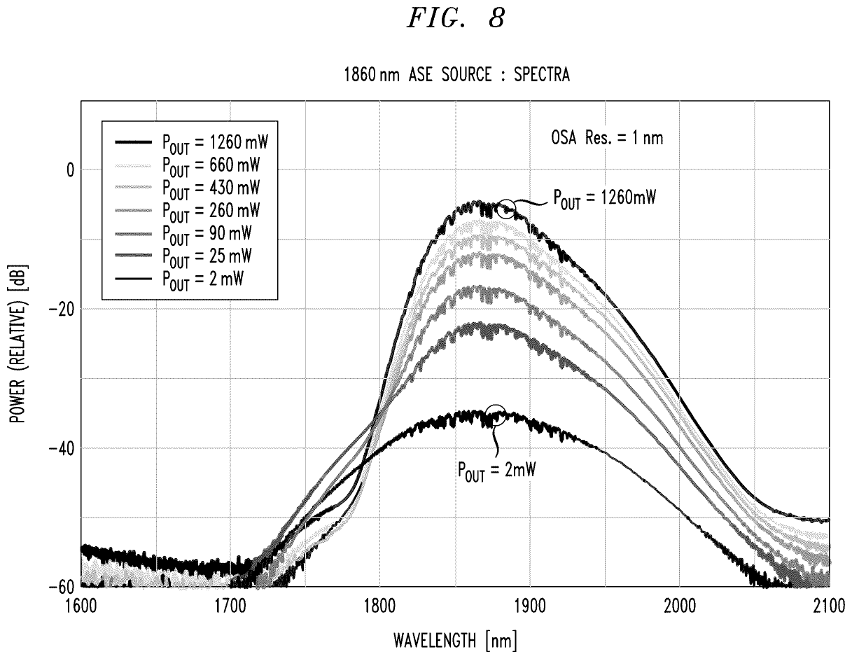

An example type of ASE-based pump source 20-1 suitable for use in the amplifiers of the present invention is shown in FIG. 6. In this example, a doped fiber-based arrangement is used to create a suitable bandwidth of ASE emission in the presence of a conventional pump beam (single wavelength) of an appropriate value. Here, ASE pump source 20-1 is shown as comprising a section of Thulium-doped (Tm-doped) fiber 50, with a WDM 52 disposed beyond the output of Tm-doped fiber 50. A semiconductor laser diode 54 (or similar device) is used to provide an initial optical input to doped fiber 50. In this case, laser diode 54 comprises a semiconductor laser operating at a wavelength of 1550 nm.

As shown, the input beam created by laser diode 54 is applied as an input to WDM 52, which functions to direct this input beam (in a counter-propagating direction) into doped fiber 50. The presence of this beam at 1550 nm with the Tm dopant in the single-clad doped fiber 50 results in creating spontaneous emission that is centered at about 1860 nm (as shown in the associated diagram). The created ASE will propagate in both directions through doped fiber 50, exiting pump source 20-1 as an ASE pump beam (denoted P_{ASE}), as shown in FIG. 6. As with standard fiber-based laser/amplifier configurations, the ASE generating configuration of FIG. 6 includes isolators disposed along the signal path. Here, a first isolator 56 is disposed at the reflection point of doped fiber 50 and a second isolator 58 is disposed along the output path beyond WDM 52.

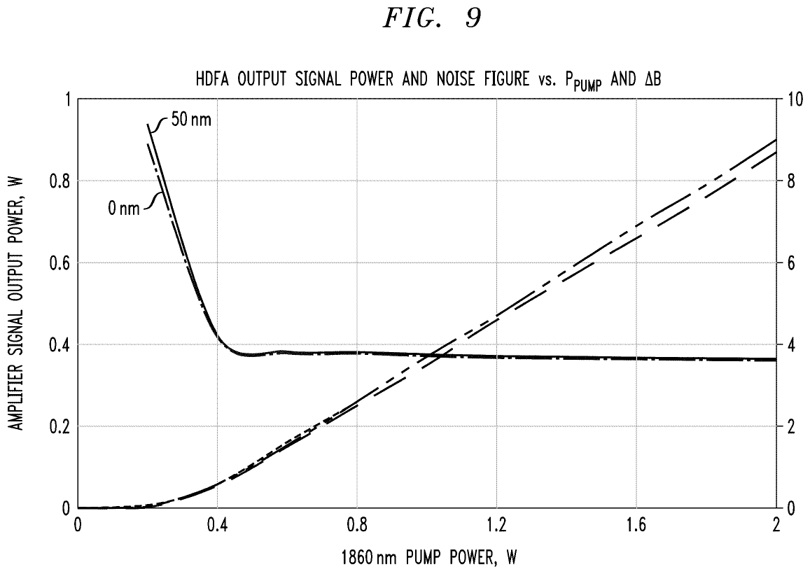

It is anticipated that many applications for using an ASE-based pump will require the use of a pump beam having a relatively high output power (e.g., on the order of 2-4 W). In these instances, it may be appropriate to use a multi-stage ASE source. FIG. 7 illustrates an exemplary two-stage ASE source 20-2 formed in accordance with the principles of the present invention. A first stage of two-stage ASE source 20-2 is shown as comprising the elements described above in association with FIG. 6. Here, however, the output from laser diode pump source 54 is first passed through a power splitter 60, creating individual beams for priming each stage (beam P1 applied as an input to first WDM 52 and beam P2 applied as an input to a second WDM 62. Second WDM 62 is shown as positioned at the output of a second section of Tm-doped fiber 64, where the output ASE generated as discussed above in association with FIG. 6 is applied as an input to Tm-doped fiber 64. The presence of pump P2 in second doped fiber section 64 (again, in this case, counter-propagating with respect to the initially-generated ASE) thus further increases the gain level of the propagating ASE. The final, high power ASE output from second doped fiber 64 passes through second WDM 62 and an output isolator 66 before exiting two-stage ASE source 20-2.

FIG. 8 plots the spectral evolution of ASE source 20-2 as a function of ASE pump power. The graph demonstrates that for an output pump power up to a level of about 1.25 W, the ASE source exhibits similar behavior as a conventional single wavelength pump, both in terms of center wavelength (e.g., 1860 nm) and 3 dB bandwidth (e.g., about 50 nm), while exhibiting no instability or self-lasing. It should be noted that the 1860 nm center wavelength coincides with one of the pump wavelengths that produces the best power conversion efficiency in Ho-doped fiber.

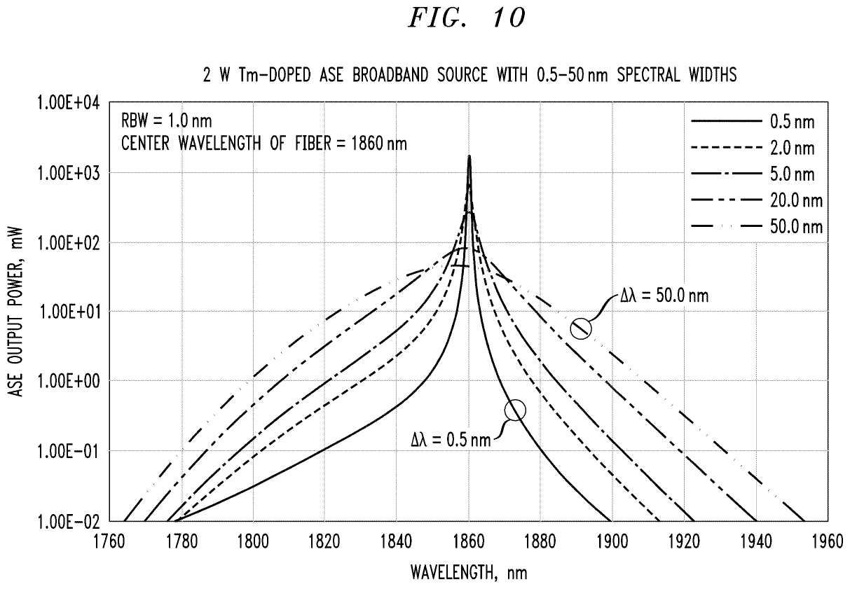

The values of output power and noise figure (NF) have been simulated for the configuration of HDFA 10 as shown in FIG. 1, again based upon an input signal Sin operating at a wavelength λ_{S} of 2050 nm, with an input power on the order of 1 mW. The simulation results are shown in FIG. 9, where the 3 dB width of ASE pump source 20 was set to 50 nm (to match the experimental 3 dB spectral width). For comparison, the results from a conventional single wavelength (i.e., monochromatic) pump beam are also shown in FIG. 9. The simulation results for the 50 nm bandwidth ASE pump source indicate that the output power increases linearly with pump power, with an output power of 0.9 W for a 2 W ASE pump and a 38% slope efficiency. Also the NF value is shown to plateau around 3.7 dB for more than 0.5 W of 1860 nm power. In contrast, the conventional pump laser diode (single wavelength) has no change in the NF evolution, and exhibits a slightly better conversion efficient of 40% (compared to the 38% of the inventive ASE pump).

One additional feature that may be incorporated with two-stage ASE source 20-2 to improve its efficiency is the additional of a bandpass filter (BPF) 68 between the two stages, as shown in FIG. 7. BPF 68 is configured to exhibit a center wavelength within the natural ASE emission spectrum of the beam exiting first doped fiber 50. By including BPF 68, the output from first doped fiber 50 exhibits a slightly narrower bandwidth, which concentrates the generated power and forms a pump input to the second stage of the ASE source. The applied input saturates the second stage of ASE source 20-2 to extract maximum ASE output power.

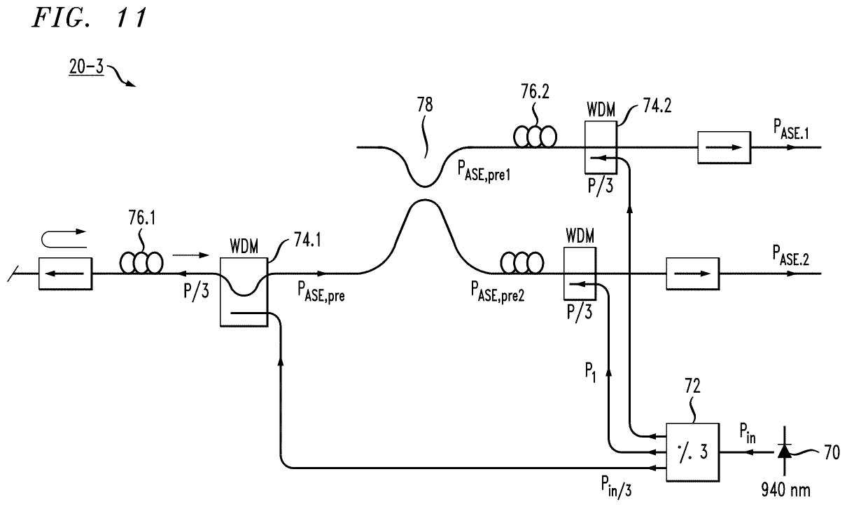

The inclusion of BPF 68 has been simulated (with various spectral widths ranging from 0.50 to 50.00 nm), with the corresponding evolution of the ASE output power as a function of wavelength and spectral width shown in the plots of FIG. 10. It is to be noted that the average (CW) power of ASE source 20-2 was held constant at 2 W for all of the various spectral widths of BPF 68 that were investigated. As the bandwidth of BPF 68 decreases, it is evident that the peak output power increases which the average power remains about the same. This embodiment of the present invention, therefore, provides a design that allows for the ASE output power to be concentrated over a limited bandwidth and thus optimize the pumping efficiency of HDFA 10.

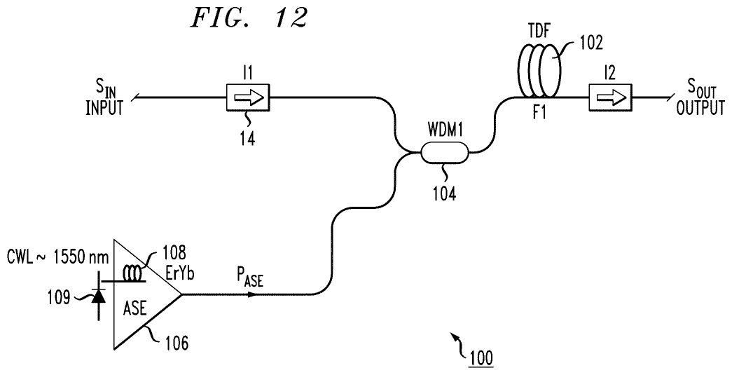

Other configurations for applying the generated ASE pump to multi-stage doped fiber amplifiers are contemplated. Beyond the example of FIG. 7 where a 50/50 power splitter 60 is used to create a pair of ASE pump inputs that are applied in counter-propagating directions to their respective sections of doped fiber, it is possible to utilize separate ASE sources for each stage. Other splitting arrangements of a single ASE pump source are envisioned as well. FIG. 11, for example, illustrates an alternative ASE pump source 20-3 that may be used to supply ASE pump light to individual stages of a multi-stage fiber amplifier. ASE pump source 20-3 is shown as including an input seed pump laser diode 70 operating at suitable wavelength, with respect to the dopant included within the gain fibers of ASE pump source 20-3 to create ASE output centered on a desired pump wavelength. Here, the pair of ASE outputs are to be centered on 1560 nm, so ASE pump source 20-3 is configured to use a seed laser diode 70 operating at 940 nm and doped fiber sections including Er dopant.

Continuing with reference to FIG. 11, the seed beam created by laser diode 70 is first passed through a three-way power splitter 72 to create a set of equal power sub-beams (the power denoted by P/3) directed toward the three individual sections of doped fiber. In particular, a first sub-beam P₁ is passed through a first WDM 74.1 and applied as an input to a first section of doped fiber 76.1. The initial amount of ASE generated by the interaction of sub-beam P₁ with the gain fiber dopant, denoted here as P_{ASE}, pre will thereafter pass through WDM 74.1 and be applied as an input to an ASE power splitter 78. The pair of outputs from ASE power splitter 78, shown as P_{ASE,pre.1} and P_{ASE,pre.2}, are then used to create the pair of ASE output beams (shown as P_{ASE.1} and P_{ASE.2}, respectively).

As shown, P_{ASE,pre.1} is shown as coupled into a second section of doped fiber 76.2. A pump sub-beam P2 (from pump power splitter 72) is shown as coupled into a WDM 74.2 that is disposed at the output of doped fiber 76.2. This pump sub-beam P2 then interacts with the initially-created P_{ASE,pre.1} in a known manner to create first ASE output P_{ASE.1}, where the output exhibits a pump power sufficient for generating gain within an associated fiber amplifier (not shown).

Similarly, a remaining, third pump sub-beam P3 is coupled into a WDM 74.3 that is positioned at the output of a third section of gain fiber 76.3. With the initially-created ASE P_{ASE,pre.2} provided as an input to gain fiber section 76.3, the ASE generated within gain fiber 76.3 thereafter passes through WDM 74.3 and is used as the second ASE pump output P_{ASE.2}.

While this particular embodiment of ASE pump source 20-3 utilizes a single laser diode 70 to interact with all three sections of doped fiber 76, it is to be understood that individual laser diodes may also be used to provide a seed input to each section of doped fiber.

The results described above for using an ASE pump source in an Ho-based fiber amplifier are similarly applicable to Tm-based fiber amplifiers (both single stage and multi-stage) which are also used fiber-based lasers and amplifiers within the eye-safe operating range of about 1.7 μm-2.1 μm. The inventive concepts may be extended to fiber amplifiers based on other rare-earth dopants as well, such as Erbium (Er), Ytterbium (Yb), etc., as long as the ASE pump source is configured to provide pump light within a band that includes a pump wavelength suitable for energizing absorbance within the particular dopant being used (e.g., ASE light including the wavelength 980 nm for an Er-doped device, ASE light including the wavelength 910 nm for Yb-doped device, etc.).

In another particular example embodiment, FIG. 12 illustrates a Tm-doped fiber amplifier 100 that utilizes an ASE-based pump source in the same manner as described above for HDFA 10 in association with FIG. 1. TDFA 100 is shown as comprising a section of Tm-doped fiber 102, with a WDM 104 used to supply the ASE pump input to doped fiber 102. In this case of an TM-doped gain fiber, an ASE pump source 106 is configured to provide a broadband Gaussian output with a center wavelength of about 1550 nm (and extending perhaps ±30 nm or more around this wavelength). In order to achieve the result of a Gaussian beam centered at 1550 nm, an exemplary ASE source 106 may comprise one or more sections of Erbium-doped (Er-doped) fiber 108 or Erbium-Ytterbium co-doped fiber (Er—Yb doped). A semiconductor laser diode pump source 109 operating at 980 nm (for Er-doped) or 940 nm (for Er—Yb co-doped) is coupled into doped fiber 108 of ASE source 106, where an input pump beam at this wavelength interacts with the dopants in a manner that generates output ASE centered at about 1550 nm. Either single-clad or double-clad fiber may be used for doped fiber 108. Using double-clad fiber enables the generation of multi-watt output power, but single clad fiber has also been found to provide acceptable levels of output power. To achieve better absorption by the Tm-doped fiber 102, a bandpass filter may be used (in combination with a two-stage ASE source), as described above in association with two-stage ASE source 20-2 of FIG. 7.

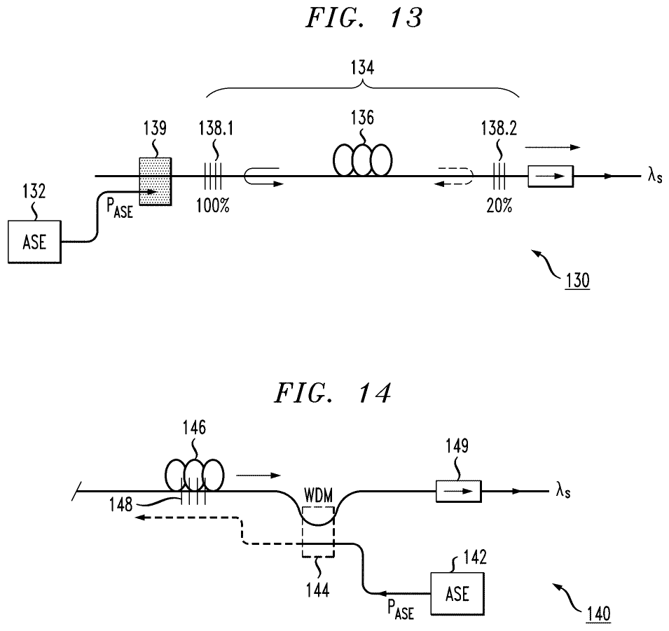

Recall that it is proposed to utilize ASE pump sources for doped fiber-based lasers as well as amplifiers. FIG. 13 illustrates an exemplary Fabry-Perot (FP) laser 130 for creating an output laser beam operating at a selected wavelength λ_{S} based upon an input ASE pump source 132. In particular, FP laser 130 is shown as including a resonant cavity 134 comprising a length of rare-earth doped optical fiber 136 disposed between a pair of fiber Bragg gratings (FBGs) 138 that are used to define the reflective cavity boundaries. A first FBG 138.1 is shown as configured to provide 100% reflectivity of signal wavelength λ_{S}, with a second, remaining FBG 138.2 having a reflectivity less than 50%, and in this particular example a reflectivity of 20%. An optical coupler 139 is used to introduce the ASE pump from source 132 into resonant cavity 134 via first FBG 138.1. The presence of the ASE beam within doped fiber 136 triggers stimulated emission which is then controlled by the reflecting wavelength values of FBGs 138 to create a lasing output at the desired wavelength λ_{S}.

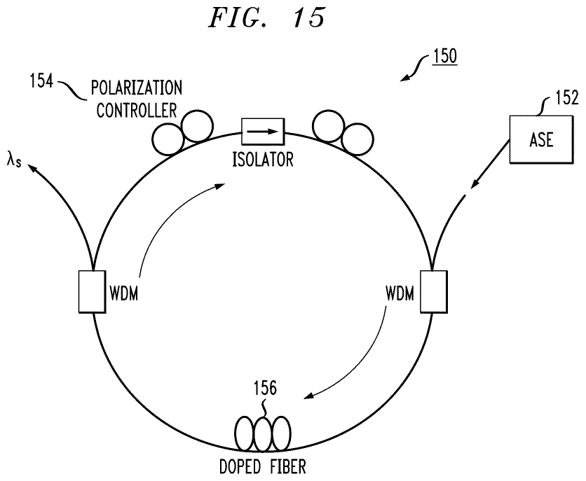

A distributed feedback (DFB) rare-earth doped fiber laser 140 is shown in FIG. 14, which illustrates the use of an ASE source 142 to assist in the generation of a laser output at a defined wavelength λ_{S}. Here, a WDM 144 is used to couple the ASE pump light into a rare-earth doped fiber 146. A distributed grating 148 is included within fiber 146, with the generated laser output passing through WDM 144 (and also isolator 149) before exiting the DFB laser device.

A fiber-based ring laser 150 is shown in FIG. 15 as using an ASE source 152 to provide the pump light that initializes the creation of the laser output. Similar to other ring laser structures well-known in the art, the exemplary structure includes a polarization-preserving arrangement 154 separate from a section of rare-earth doped fiber 156 into which the ASE pump light is injected. Alternatively, ring laser 150 may be formed of polarization-maintaining fiber and eliminate the need to include a discrete polarization-preserving arrangement. An input WDM 158.1 is used to introduce the ASE pump to doped fiber 156, and a separate output WDM 158.2 is used to out-couple a portion of the created laser output, allowing the remaining laser energy to continue to circulate around the ring.

While certain preferred embodiments of the present invention have been illustrated and described in detail, it should be apparent that modifications and adaptations to these embodiments may occur to one skilled in the art without departing from the scope of the present invention as set forth in the claims appended hereto. Indeed, the described embodiments are to be considered in all respects as only illustrative and not restrictive.

What is claimed is:

1. An optical device, comprising:
a section of rare-earth doped optical fiber; and
an amplified spontaneous emission (ASE) pump source configured to provide broadband ASE pump light spanning a bandwidth Δλ surrounding a selected center wavelength λₚᵤₘₚ, the provided broadband ASE pump light coupled into the section of rare-earth doped optical fiber so as to interact with a rare-earth dopant within a core region of the section of rare-earth doped optical fiber and provide an amplified optical output therefrom.

2. The optical device as defined in claim 1 wherein the ASE pump source generates a Gaussian-shaped output centered at about λₚᵤₘₚ.

3. The optical device as defined in claim 2 wherein the bandwidth Δλ comprises a 3 dB bandwidth of the Gaussian-shaped output.

4. The optical device as defined in claim 1 wherein the bandwidth Δλ is no less than 10 nm.

5. The optical device as defined in claim 1 wherein the broadband ASE pump source comprises a laser diode selected to operate at an initial wavelength λᵢₙᵢₜ;
a section of rare-earth doped optical fiber; and
a wavelength division multiplexer (WDM) disposed at the output of the section of rare-earth doped optical fiber, where the output of the laser diode is applied as an input to the WDM and thereafter directed into the section of rare-earth doped fiber and generates ASE as it propagates therealong, the generated ASE directed through the WDM and forming the broadband ASE pump light output of the ASE pump source.

6. The optical device as defined in claim 5 wherein the section of rare-earth doped fiber of the broadband ASE pump source comprises a section of single-clad optical fiber.

7. The optical device as defined in claim 5 wherein the section of rare-earth doped fiber of the broadband ASE pump source comprises a section of double-clad optical fiber.

8. The optical device as defined in claim 5 wherein the broadband ASE pump source further comprises
a first optical isolator disposed at a far-end termination of the section of rare-earth doped optical fiber; and
a second optical isolator disposed along an output signal path beyond the WDM.

9. The optical device as defined in claim 5 wherein the section of rare-earth doped fiber of the broadband ASE pump source comprises a section of Tm-doped optical fiber, for providing broadband ASE output surrounding a center wavelength λₚᵤₘₚ Of 1860 nm.

10. The optical device as defined in claim 9 wherein the laser diode of the broadband ASE pump source operates at a wavelength λᵢₙᵢₜ of 1550 nm.

11. The optical device as defined in claim 1 wherein the ASE pump source comprises
a first ASE generation stage comprising
a first section of rare-earth doped optical fiber; and
a first wavelength division multiplexer (WDM) disposed at the output of the first section of rare-earth doped optical fiber, where the output of a laser diode is applied as an input to the first WDM and thereafter directed into the first section of rare-earth doped fiber and initially generates ASE as it propagates therealong; and
a second ASE generation stage coupled to the output of the first ASE generation stage and receiving as a first input the initially-generated ASE, the second ASE generation stage comprising:
a second section of rare-earth doped optical fiber; and
a second wavelength division multiplexer (WDM) disposed at the output of the second section of rare-earth doped optical fiber, where the output of a laser diode is applied as an input to the second WDM and thereafter directed into the second section of rare-earth doped fiber and generates ASE as it propagates therealong, the generated ASE directed through the second WDM and provided as the output ASE light from the broadband ASE pump source.

12. The optical device as defined in claim 11, further comprising:
a laser diode configured to operate at a wavelength known to trigger ASE within the first and second sections of rare-earth doped fiber; and
an optical power splitter disposed at the output of the laser diode for providing a first laser diode output directed into the first WDM and a second laser diode output directed into the second WDM.

13. The optical device as defined in claim 11, further comprising:
a first laser diode configured to operate at a wavelength known to trigger ASE within the first section of rare-earth doped fiber, an output from the first laser diode applied as an input to the first WDM of the broadband ASE pump source; and
a second laser diode configured to operate at a wavelength known to trigger ASE within the second section of rare-earth doped fiber, an output from the second laser diode applied as an input to the second WDM of the broadband ASE pump source.

14. The optical device as defined in claim 11, wherein the broadband ASE pump source further comprises a bandpass filter disposed between the output of the first ASE generation stage and the input of the second ASE generation stage.

15. The optical device as defined in claim 1, wherein the section of rare-earth doped optical fiber includes a rare-earth dopant selected from the group consisting of: Holmium (Ho), Thulium (Tm), Erbium (Er), Ytterbium (Yb), and co-doped Er—Yb.

16. The optical device as defined in claim 1, wherein the device comprises a rare-earth doped fiber optical amplifier and further comprises
an input coupler disposed at a first end termination of the section of rare-earth doped optical fiber, the input coupler for introducing an input optical signal Sin operating at a defined wavelength λₛ into the section of rare-earth doped optical fiber, wherein the presence of the broadband ASE pump light creates an increase in optical power of the propagating input signal as it exits the rare-earth doped optical fiber as an amplified output signal.

17. The optical device as defined in claim 16 wherein the input coupler comprises a WDM, with the ASE pump light applied as a second input such that both the input optical signal Sin and the broadband ASE pump light P_{ASE} are multiplexed together and introduced into the first end termination of the section of rare-earth doped optical fiber to form a co-propagating optical amplifier configuration.

18. The optical device as defined in claim 1, wherein the device comprises a fiber laser configured such that the broadband ASE pump absorbs the rare-earth ions, creating light that makes multiple passes through the section of rare-earth doped fiber, imparting gain on each pass so as to reach a lasing threshold and generating an output laser beam.

19. The optical device as defined in claim 18, wherein the fiber laser further comprises a pair of reflective elements disposed at opposite end terminations of the section of rare-earth doped optical fiber to create a laser cavity.

20. The optical device as defined in claim 18, wherein the section of rare-earth doped optical fiber is formed to include a grating structure for creating a distributed feedback fiber laser in the presence of the broadband ASE pump light.

21. The optical device as defined in claim 18, wherein the fiber laser comprises a ring topology.
